(19) United States
(12) Patent Application Publication
(10) Pub. No.: US 2013/0132757 A1
(43) Pub. Date: May 23, 2013

(54) POWER-ON CONTROLLING METHOD AND SYSTEM THEREOF

(71) Applicant: Chia-Hsiang Chen, Taipei (TW)

(72) Inventor: Chia-Hsiang Chen, Taipei (TW)

(73) Assignee: INVENTEC CORPORATION, Taipei (TW)

(21) Appl. No.: 13/348,082

(22) Filed: Jan. 11, 2012

(30) Foreign Application Priority Data
Nov. 23, 2011 (TW) 100143000

(51) Int. Cl. G06F 1/32

(52) U.S. Cl. 713/330

(57) ABSTRACT

A power-on controlling method and system are provided. The system includes a power management unit, a voltage regulating module and a power controller. After booting a computer system, the power controller controls the power managing unit to selectively execute a discontinuous mode or a continuous mode according to a selection command, so as to control the voltage regulating module to regulate a system voltage supplied for electric elements in the computer system, thus finishing the system initialization action, and improving the flexibility in monitoring the power of computer system.

### CROSS-REFERENCE TO RELATED APPLICATIONS

This non-provisional application claims priority under 35 U.S.C. §119(a) on Patent Application No(s). 100143000 filed in Taiwan, R.O.C. on Nov. 23, 2011, the entire contents of which are hereby incorporated by reference.

### BACKGROUND

1. Technical Field

The present disclosure relates to a power-on controlling method and system thereof, and more particularly to a power-on controlling method and system capable of selecting a discontinuous mode or a continuous mode to supply power in a power-on process.

2. Related Art

Generally speaking, the system initialization process when the computer system is powered on has two major phases. One phase is executed before the step of extracting a base input output system (BIOS) program code for the first time, and the other phase is executed after the step of starting the extraction of the BIOS program code. The major program of the former boots all basic voltage rails and releases a reset signal in an appropriate “basic boot sequence”. On a system main board of the computer system, a typical system chipset is usually used to control the basic boot sequence.

When the system main board is powered on, the boot sequence controller transfers a basic enable signal according to a basic boot sequence predetermined in a basic state machine or a sequence machine in the boot sequence controller, so as to enable different power supply units to carry out AC-DC conversion and voltage regulation, thereby supplying power for booting different electric elements.

However, since the boot sequence controller can only be set in accordance with the standard of each platform to continuously execute the power sequence control in each stage, so as to turn on the power progressively, until the system enters a run time stage. In another case, when the voltage is accidentally interrupted, the boot sequence controller fails to monitor every initialization status/event or every voltage rail on the system main board in the whole process of system initialization. When the power initialization failure occurs, the boot sequence controller is hard to find out which voltage rail has the failure precisely, i.e. if the power supply of the electric element on every voltage rail is abnormal. Furthermore, in the course of the system initialization, merely several common initialization status related to the power, such as a power good indication and a system reset signal status can be monitored. For the computer system requiring a high stability, the fact that only these basic power status signals are monitored cannot meet the requirements of the manager or the system designer for monitoring and testing the system status under the voltage condition corresponding to each voltage rail, and thus the above design lacks the application flexibility.

### SUMMARY

In some embodiments, to power-on controlling system disclosed in the present disclosure includes a power management unit, a voltage regulating module and a power controller. The power managing unit is respectively connected to the voltage regulating module and the power controller. The power managing unit selectively executes a power sequence control in a discontinuous mode or a continuous mode according to a selection command, and controls the voltage regulating module to regulate a system voltage. The power controller controls the power managing unit and controls the regulation of the system voltage.

According to some embodiments, a power-on controlling method of the present disclosure, firstly, the power-on controlling system is booted to supply the system voltage. Next, the power management unit selects the discontinuous mode or the continuous mode according to the received selection command to execute the power sequence control, so as to control the voltage regulating module to regulate the system voltage supplied for electric elements in the computer system, thus finishing the initialization.

### BRIEF DESCRIPTION OF THE DRAWINGS

The present disclosure will become more fully understood from the detailed description given herein below for illustration only, and thus are not limitative of the present disclosure, and wherein:

FIG. 1 is a schematic structural view of a power-on controlling system of the present disclosure; and

FIG. 2 is a flow chart of a power-on controlling method of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In view of the above problems, some embodiments of the present disclosure provides a power-on controlling method and system, thereby solving the deficiencies of lacking the application flexibility of monitoring during the system initialization.

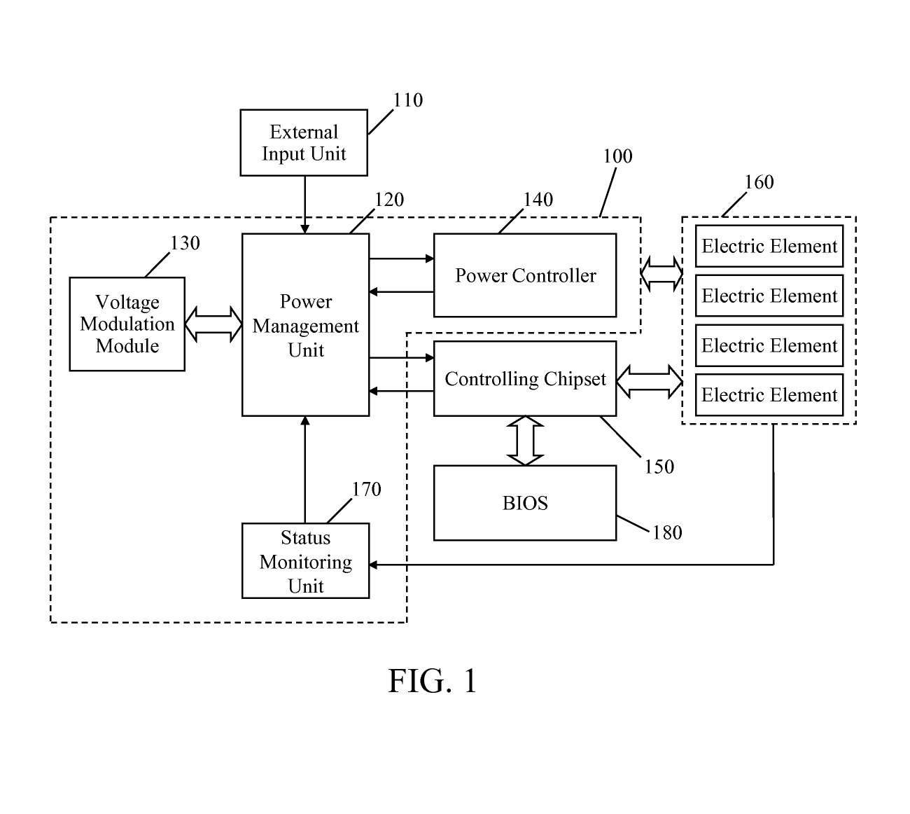

To further explain the technical features and embodiments of the present disclosure, referring to FIG. 1, a schematic structural view of a power-on controlling system of the present disclosure is shown. The present disclosure is adapted for controlling the initialization of the starting power supply after a computer system (not shown) is powered on before entering the BIOS.

The computer system according to the embodiments of the present disclosure includes a power-on controlling system 100, a controlling chipset 150, an electric element unit 160 and a BIOS 180. The power-on controlling system 100 includes a power management unit 120, a voltage regulating module 130, a power controller 140 and a status monitoring unit 170.

An external input unit 110 is independently disposed outside the computer system or is integrated with the computer system, for inputting a command to the computer system. The external input unit 110 may be a device used for inputting commands such as a computer keyboard and functional keys. In another case, the external input unit may be used to input the commands by a transfer interface of the BMC and the power managing unit in a remote terminal (e.g. a network interface) input manner. In addition, the command may be input through a touch panel (not shown), and then the command is transferred to the power management unit 120 by the access processing of the power controller 140 and the controlling chipset 150, for the power management control.

The power management unit 120 is connected to the external input unit 110, for managing a program of the power sequence control according to a selection command input from the outside or in-built, that is, the power sequence may be selected to continuously execute the power sequence control of each electric element in the electric element unit 160 inside the computer system or may be selected to execute the power sequence control of each electric element in the electric element unit 160 inside the computer system at a time. Although one electric element unit is illustrated, those skilled in the art should understand that the number of the electric elements of the computer system e.g. one or more the electric element like a circuit element and a logic circuit in the computer system.

The voltage regulating module 130 is connected to the power management unit 120, for regulating the system voltage of the computer system to the output voltage required by each electric element of the electric element unit 160 according to the control of the power management unit 120, so as to further supply the output voltage to each electric element. When the voltage regulation for one stage of power sequence control is executed each time, the power management unit 120 sends a boot signal to the voltage regulating module 130, and the voltage regulating module 130 returns a power good signal to the power management unit 120, so as to ensure that the power supply of the electric element corresponding to the stage is normal. Then, the power management unit 120 and the voltage regulating module 130 will perform the next stage of power sequence control. The execution sequence of the power sequence control is sequentially supplying power from the electric element with a high voltage value to the electric element with a low voltage value. Definitely, the power may be sequentially supplied from the electric element with a low voltage value to the electric element with a high voltage value.

The controlling chipset 150 is connected to the power management unit 120, for communicating the system with peripheral devices, e.g. controlling a peripheral device such as keyboard, mouse and universal serial bus having a slow speed on an industry standard architecture (ISA) bus and a peripheral device interconnect (PCI) bus and accessing the data transferred between the BIOS 180 and the bus. The controlling chipset 150 at least includes: a southbridge chip, an integrating South-North Bridge or a BMC chip commonly seen in an integrating server system.

The power controller 140 is connected to the power management unit 120, for controlling an interface between the management software and the platform management hardware of the computer system, in order to provide automatically monitoring, event recording and recovery control functions. And the power controller 140 may also be used as a network gateway between the computer system management software, and an intelligent platform management bus (IPMB) and an intelligent Chassis management bus (ICMB) interface. Therefore, in the embodiment of the present disclosure, a user may input a selection command from a remote terminal through the power controller 140 and execute the control command. In an embodiment of the present disclosure, the user may give the signals as the selection command and the execution controlling command through the external input unit 110 to the power management unit 120. In an embodiment of the present disclosure, the user may build the selection command in the power controller 140 in advance. In addition, the power controller 140 may collect system status information, and when a severe event happens, executes regulation. Usually, the system monitoring function is realized by a sensor (not shown) to monitor different system voltages, temperature and fan speed.

The power controller 140 includes an independent instant monitoring timer (not shown), which may be a watch dog in an embodiment, for detecting or diagnosing system locking caused by several kinds of the software components such as the BIOS 180, an operating system and an application program. When the watch dog generates a timeout signal, the power controller 140 automatically restarts the system, supplies the power again, or reports the locking condition to the remote terminal through a local network or a serial data machine.

In another embodiment, when the power controller 140 detects the instant monitoring timer is timeout or the voltage regulating module 130 does not receive the power good signal, the power controller 140 generates an error signal, i.e. a detection signal, and transfers the signal to the power management unit 120 through the status monitoring unit 170, so as to further inform the system interruption according to the control of the power controller 140 to perform a voltage error processing. Therefore, the status monitoring unit 170 may be disposed in the power controller 140. On the other hand, the predetermined parameters, i.e., the parameters for the operation of each electric element of the power-on controlling system 100, the predetermined value of the monitoring time in the instant monitoring timer and a predetermined value of the delay time are stored in a register unit (not shown) in the power management unit 120.

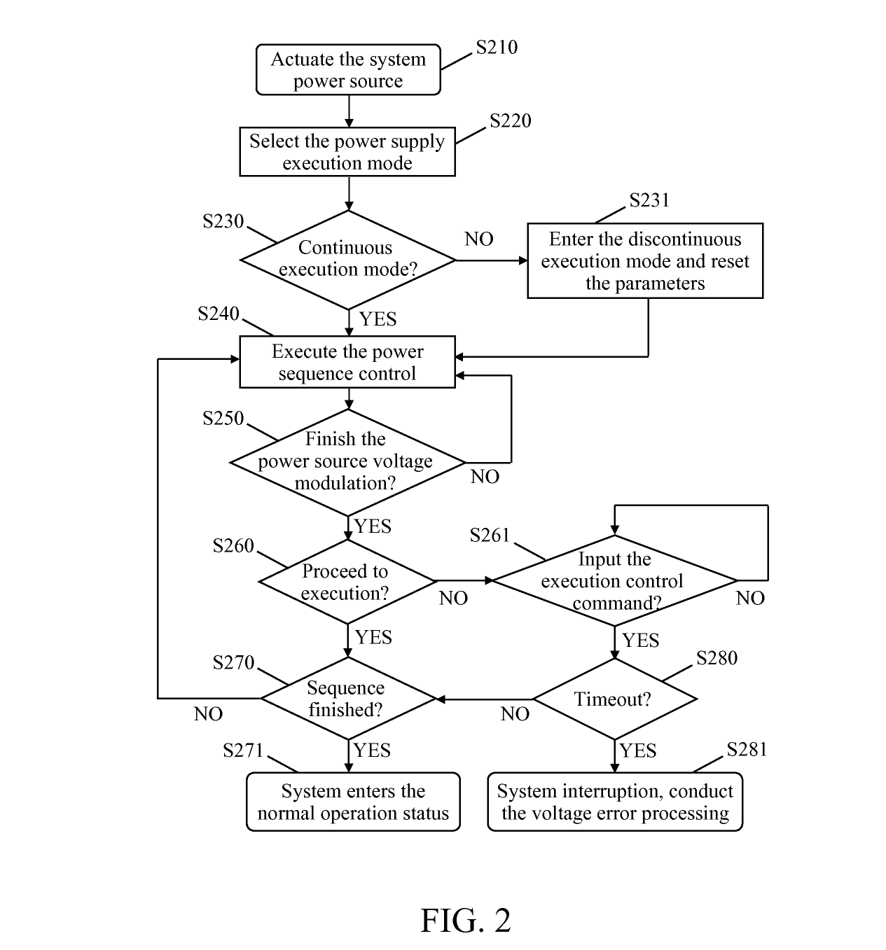

To further explain steps of the initialization controlling for the starting power supply of the power-on controlling system 100 in the present disclosure, referring to FIG. 2, a flow chart of a power-on controlling method of the present disclosure is shown.

Firstly, after a user starts the system power of the computer system and before the computer system enters an operation stage of the BIOS 180, a system voltage is supplied to the power-on controlling system 100, so that the power-on controlling system 100 operates, in step S210.

Next, according to the use requirements of the user, a selection command is input. The selection command is received by the power management unit 120 to control the power management unit 120 to select a power supply execution mode, that is, a continuous mode or a discontinuous mode, in step S220. In an embodiment of the present disclosure, the selection command may be provided by the external input unit 110. In an embodiment of the present disclosure, the selection command may be in-built set by the power controller 140. In an embodiment of the present disclosure, the selection command may also be input by the remote terminal through the power controller 140.

After the selection command is received, the power management unit 120 decides the power-on controlling system 100 operates in the continuous mode or the discontinuous mode according to the selection command, in step S230. In an embodiment of the present disclosure, the user may design that the power-on controlling system 100 is predetermined and operates in the continuous mode. That is, when the user does not input the selection command, the power-on controlling system 100 directly operates in the continuous mode, and when the user inputs the selection command, the power-on controlling system 100 is switched to operate in the discontinuous mode. In another embodiment of the present disclosure, the user may set the selection command through the interface session to select the continuous mode or the discontinuous mode for the power-on controlling system 100 in continuous mode or the discontinuous mode.

In any one of the embodiments, when the user selects the discontinuous mode for the power-on controlling system 100 continuous mode, the delay time and/or monitoring time, required by the voltage regulation and corresponded to the power sequence controlling and the voltage regulation of a signal electronic element to be driven, are reset to serve as the predetermined parameters in step S231. The reset parameter is provided by the register unit of the power management unit 120.

After the setting, the power sequence controlling is executed, that is, the voltage regulation of the electric element is executed, in step S240. According to the power sequence control at this stage, it is determined whether the power voltage regulation is finished, that is, the power management unit 120 outputs the boot signal to the voltage regulating module 130, waits and determines whether the power good signal is returned, in step S250. If the power management unit 120 does not receive the power good signal, it indicates that the power supply is not ready, and then the system returns to step S240 and proceeds to wait. The voltage regulating module 130 regulates the system voltage to the voltage value required by the electric element at this stage and forms the output voltage, so as to supply the voltage to the corresponding electric element. When the power management unit 120 receives the power good signal, the voltage regulation of this stage is finished.

After the power sequence controlling of the above stage is executed, according to the input selection command, it is determined whether to proceed to the next stage of power sequence controlling, in step S260. As the user defines the operating is executed in the discontinuous mode, the next stage of power sequence control is not directly conducted, and the power management unit 120 further determines whether the user inputs an execution controlling command from the outside, that is, by the external input unit 110 or the remote terminal, in step S261. When no input of the execution controlling command is detected, the system proceeds to wait.

When the power management unit 120 receives the execution controlling command input from the outside, the status monitoring unit 170 determines whether the system operation is timeout, that is, determines the delay time of the voltage regulation of this stage or the monitoring time exceeds the predetermined parameter, so as to generate a detection signal, in step S280. When the timeout status is detected according to the detection signal, the power controller 140 informs that the system is interrupted, and conducts the voltage error processing, in step S281. When no timeout status is detected according to the detection signal, it is further determined whether it is the last stage, which indicates that the power sequence control is finished, in step S270. If it is not the last stage, S240 is returned to proceed to the next stage of power sequence control. If it is the last stage, the computer system enters the normal operation status, in step S271. Thus, the user may determine whether problems happen to the power supply initialization of the electric element in the computer system by booting by stages one after another.

On the other hand, in step S230, in any embodiment, when the user selects the continuous mode for the power-on controlling system 100 continuous mode, the substrate managing unit 140 controls the power management unit 120 to start the power sequence controlling, that is, executing the voltage regulation of the electric element at the first stage, in step S240. According to the power sequence controlling executed in this stage, the power management unit 120 outputs the boot signal to the voltage regulating module 130, then waits and determines whether the power good signal is returned, so as to decide whether to proceed the next stage of power sequence control, in step S250. When the power management unit 120 does not receive the power good signal, it indicates the voltage supply is not ready for the electric element at this stage, and the system returns to the step S240 and proceeds to wait until the power management unit 120 receives the power good signal. After the power management unit 120 receives the power good signal, the voltage regulating module 130 supplies the voltage value i.e. the output voltage regulated for the electric element in the stage to the corresponding electric element.

After the first stage of power sequence control is finished, according to the input selection command, it is determined whether to proceed to the power sequence controlling of the next stage, in step S260. As the user defines operating in the continuous mode, it is continuously determined whether the stage is the last stage, which indicates that the power sequence control is finished, in step S270. If it is not the last stage, the procedure returns to step S240 and proceeds to the next stage of power sequence control. If the stage is the last stage, the computer system enters the normal operation status, in step S271.

The present disclosure has the advantages that the power-on controlling system provides the selection choices for the user to select the execution mode of the system power supplying, which increases the system application flexibility. The discontinuous mode is provided for the power-on controlling system, so that the user can progressively drive the electric element and conduct the progressive power supply initialization. By the progressive power supply initialization, the user can easily figure out the power supply problem of the electric elements in the computer system during the initialization and then settles the problem. Through the hardware design, the user can input the command through the external input unit or the remote terminal to control the operation of the power-on controlling system.

Note that the specifications relating to the above embodiments should be construed as exemplary rather than as limitative of the present invention, with many variations and modifications being readily attainable by a person of average skill in the art without departing from the spirit or scope thereof as defined by the appended claims and their legal equivalents.

What is claimed is:

1. A power-on controlling method, for initialization a power-on controlling system in a computer system, comprising:
supplying a system voltage;
receiving a selection command, to select a discontinuous mode or a continuous mode; and
according to the continuous mode or the discontinuous mode, deciding to continuously execute power sequence controlling or execute power sequence controlling by stages, to regulate the system voltage, so as to respectively output the regulated system voltage.

2. The power-on controlling method according to claim 1, wherein the discontinuous mode comprises:
executing power sequence controlling in one stage, to output an output voltage;
determining whether an execution controlling command is input from outside; and
determining whether the stage of power sequence control is a last stage, according to the execution controlling command, so as to decide to conduct the next stage of power sequence controlling or not to output a next output voltage.

3. The power-on controlling method according to claim 2, further comprising:
setting a delay time and/or a monitoring time;
determining whether an operation of the stage exceeds the delay time and/or the monitoring time, to generate a detection signal; and
determining whether to inform the power-on controlling system interruption or to proceed to the next stage of power sequence control, according to the detection signal;
wherein when the operation of the stage exceeds the delay time and/or the monitoring time, informing that the power-on controlling system is interrupted, when the operation of the stage does not exceed the delay time and/or the monitoring time, conducting power sequence controlling in the next stage.

4. The power-on controlling method according to claim 1, wherein the continuous mode further comprises:
executing power sequence controlling in one stage, to output an output voltage; and
proceeding to execute power sequence controlling in the next stage, to output the next output voltage.

5. The power-on controlling method according to claim 1, wherein the selection command is input from the outside of the power-on controlling system or is in-built in the power-on controlling system.

6. A power-on controlling system adapted for a computer system, comprising:
a power management unit, for selectively executing a power sequence control in a discontinuous mode or a continuous mode according to a selection command;
a voltage regulating module, connected to the power management unit, for regulating a system voltage of the power-on controlling system; and
a power controller, connected to the power management unit, for controlling the power management unit and controlling the regulation of the system voltage.

7. The power-on controlling system according to claim 6, wherein the selection command is provided by the power controller or is input from the outside of the power-on controlling system.

8. The power-on controlling system according to claim 6, further comprising a status monitoring unit, for monitoring the execution of the power sequence control of the computer system, to generate a detection signal to the power management unit.

9. The power-on controlling system according to claim 6, wherein when the power-on controlling system operates in the discontinuous mode, the power managing unit decides whether to proceed to execute one stage of power sequence control, according to an execution controlling command input from the outside of the computer system, to control the voltage regulating module, for regulating the system voltage and outputting an output voltage of the stage.

10. The power-on controlling system according to claim 6, wherein when the power-on controlling system operates in the continuous mode, the power managing unit executes one stage of power sequence control, to control the voltage regulating module to regulate the system voltage, so as to output an output voltage of the stage, and then the power-on controlling system proceeds to execute the next stage of power sequence control, to control the voltage regulating module to regulate the system voltage, so as to output the output voltage of the next stage.
